(19) United States
(12) Patent Application Publication
(10) Pub. No.: US 2010/0181416 A1
(43) Pub. Date: Jul. 22, 2010

(54) UNMANNED HELICOPTER

(75) Inventors: Osamu Sakamoto, Shizuoka-ken (JP); Ikuhiko Hirami, Shizuoka-ken (JP); Hironori Nakayama, Shizuoka-ken (JP)

Correspondence Address: YAMAHA;C/O KEATING & BENNETT, LLP, 1800 Alexander Bell Drive, SUITE 200, Reston, VA, 20191, US

(73) Assignee: Yamaha Hatsudoki Kabushiki Kaisha, Shizuoka-ken 438-8501 (JP)

(21) Appl. No.: 11/997,736

(22) PCT Filed: Jul. 31, 2006
(86) PCT No.: PCT/JP2006/315116

§ 371 Date: Feb. 5, 2010

(30) Foreign Application Priority Data
Aug. 4, 2005 (JP) 2005-226938

(51) Int. Cl. B64C 27/06; B64D 33/10; B64C 27/04

(52) U.S. Cl. 244/17.21

(57) ABSTRACT

An airframe (1a) having a main body (4) and a tail body, a main rotor (6) disposed above the main body (4) and driven by an engine inside the airframe (1a), and a tail rotor disposed in a rear part of the tail body (5) are provided. A pair of support legs (8, 8) at left and right sides extending downward from left and right sides in a lower part of the main body (4) and a pair of skids (9) on left and right sides provided on the lower ends of the support legs (8) and positioned out of the main body (4) in the width direction of the airframe (1a) in a front view are provided. A radiator (71) at a position more frontward than the front ends of the skids (9) in a side view, formed extendedly downward from the vicinity of a bottom surface (83) of the front part of the main body, and having wind reception surfaces oriented to the longitudinal direction of the airframe is provided. Lateral ends of the radiator (71) in the width direction of the airframe (1a) project outward beyond lateral edges of a main body bottom surface (83) in the vicinity of the radiator (71) in a front view. Further, the lateral ends (71a) of the radiator (71) are positioned inward in the width direction of the airframe (1a) within skids 9.

### TECHNICAL FIELD

The present invention relates to an unmanned helicopter having a radiator.

### BACKGROUND ART

Conventionally, an unmanned helicopter which is controlled by remote control performed by an operator watching an airframe is used for applying agrochemicals or for photographing aerial images, videos, and the like from the sky. An unmanned helicopter in recent years can fly out of the operator's sight by utilizing the GPS. As a result, an unmanned helicopter of this type can photograph images of a place such as, for example, a volcano and a disaster site to which it is difficult for a manned helicopter to go closer and, actually, plays an active part in such a place. For example, an unmanned helicopter for applying chemicals such as agrochemicals is disclosed in JP-A-2002-166893, while an unmanned helicopter for photographing aerial images and the like is disclosed in JP-A-2002-293298.

A conventional unmanned helicopter is provided with a radiator oriented to an obliquely front upward direction in the frontmost part of the airframe and in the middle part in the width direction of the airframe. When the airframe moves forward, the front surface of the radiator receives a wind caused by the flight and also receives a downwash from the main rotor. As a result, the cooling water of the radiator is cooled during the forward movement, and, consequently, the engine is cooled.

For ease of operation, an unmanned helicopter used for applying agrochemicals is generally used in a manner in which the unmanned helicopter is repeatedly moved forward and backward in a range within a predefined area. In this case, as the radiator cannot receive a wind on the front during a backward movement, cooling performance decreases. On the other hand, while agrochemicals are applied, the unmanned helicopter is moved forward after moved backward in a certain distance. Therefore, a flight such as hovering or a backward movement at a very slow speed is rarely performed. Accordingly, there is no case in which the radiator at the front does not receive a wind for a long time. As a result, the engine is sufficiently cooled solely by the radiator provided at the front of the airframe.

A helicopter, however, is frequently moved backward at a very slow speed, stopped during a flight (hovering), and operated in other manners besides forward or backward movement. There may be a case in which an unmanned helicopter for monitoring, for photographing observation images, for photographing fixed point images, and for other purposes must hover in the sky or move backward at a very slow speed. If a long flight is performed in such a condition, the wind caused by the flight is not easily received by the front of the airframe. Consequently, the amount of air flowing into the radiator is reduced. As a result, while such a flight is performed, it is not possible to sufficiently cool the engine.

An unmanned helicopter having an engine with improved cooling performance is disclosed in JP-A-2002-193193, for example. Besides a radiator (a main radiator) provided at the front in the middle part in the width direction of the airframe, the unmanned helicopter disclosed in the publication is provided with a sub-radiator on the bottom side of the front part or on the sides of the airframe. FIG. 9 shows a conventional unmanned helicopter provided with the sub-radiator.

FIG. 9 shows a front view of the conventional unmanned helicopter provided with the sub-radiator. An unmanned helicopter 100 has a main radiator 103 at the front of a main body 102 covering the outside of an airframe 101. Further, the unmanned helicopter 100 has sub-radiators 104 and 105 on the bottom side of the front part or on the sides of the airframe 101. A pair of support legs 106 and 106 at the left and the right sides extending downward from the left and the right sides in the bottom part of the main body 102 is provided on the bottom part of the airframe 101. A skid 107 is provided at the bottom end of each of the support legs 106 and 106. Each skid 107 is positioned out of the main body 102 in the width direction of the airframe 101 in the front view of the airframe 101.

The sub-radiator 104 provided on the bottom side of the front part of the airframe is extendedly provided in the width direction of the airframe 101 in the vicinity of the bottom surface of the airframe 101. In addition, the sub-radiator 104 is so formed that the surface for receiving a wind caused by a flight (hereinafter referred to as wind reception surface) are oriented in the longitudinal direction of the airframe 101. The length of the sub-radiator 104 is equal to or less than the width dimension of the bottom surface of the front part of the main body. The sub-radiators 105 provided on the both sides of the airframe 101 are extendedly provided in the vertical direction near the side of the airframe 101. In addition, the sub-radiator 105 is so formed that the wind reception surface is oriented in the longitudinal direction of the airframe 101. Though the sub-radiators 104 and 105 are not shown in the drawing, they are at positions more frontward than the front ends of the skids 107 in the side view of the airframe 101 and extendedly provided downward from the vicinity of the bottom surface of the front part of the main body. As the sub-radiators 104 and 105 are provided as described above, the main radiator 103 is thereby assisted and its cooling performance is enhanced.

### DISCLOSURE OF THE INVENTION

### Problem to be Solved by the Invention

However, even if the sub-radiator 104 is provided on the bottom side of the front part of the airframe, when hovering is performed or a backward movement is made at a very slow speed for a long time, the engine may overheat. This is because a wind reception area (an area receiving a wind caused by a flight) of the sub-radiator 104 is equal to or smaller than that of the main radiator 103 and further because a part of the wind coming from the rearward is interrupted by a muffler and another accessory disposed behind the sub-radiator 104. Therefore, the conventional unmanned helicopter is provided with the sub-radiator 104 on the bottom side of the front part of the airframe. Even so, there is a problem in which air temperature should be considered as a restriction in order to prevent the engine from overheating when it is determined whether or not a flight is possible or when the detail of a flight is determined.

On the other hand, the sub-radiator 105 provided on the sides of the airframe sufficiently receives a wind even during hovering or a backward movement at a very slow speed. The sub-radiator 105, however, projects sideways in relation to the airframe 101 beyond the skid 107 of the unmanned helicopter 100 provided with the sub-radiator 105, which causes a problem during transport. Specifically, when the unmanned helicopter 100 is carried, for example, from a narrow workspace or the like to the outside, it is likely that the sub-radiator 105 comes in contact with a wall at an inlet. Therefore, the unmanned helicopter 100 needs to be carefully carried. As a result, it takes an unnecessarily long time to carry the unmanned helicopter 100. In addition to this, when the unmanned helicopter 100 is carried by a load carrier of a vehicle, it is likely that the sub-radiator 105 comes in contact with the walls on the left and the right sides at the inlet of the load carrier because the sub-radiator 105 projects beyond the skid 107. Moreover, a larger space is required for the unmanned helicopter 100.

An object of the present invention made in view of such problem described above is to provide an unmanned helicopter having a compactly formed airframe which achieves a sufficient effect on cooling an engine even during a backward movement or hovering, which a wind is hardly received from the forward direction of the airframe.

### Means for Solving the Problem

To achieve the purpose, the unmanned helicopter according to the present invention includes: an airframe having a main body and a tail body continued to a back part of the main body; a main rotor disposed above the main body and driven by an engine inside the airframe; a tail rotor disposed in a rear part of the tail body; a pair of support legs at left and right sides extending downward from left and right sides in a lower part of the main body; a pair of skids on left and right sides provided at the bottom ends of the support legs and positioned out of the main body in the width direction of the airframe in the front view; and a radiator at a position more frontward than the front ends of the skids in the side view of the airframe, extendedly provided downward from the vicinity of the bottom surface of the front part of the main body, and having wind reception surfaces oriented to the longitudinal direction of the airframe, in which lateral ends of the radiator in the width direction of the airframe project outward beyond lateral edges of a main body bottom surface in the vicinity of the radiator in the front view and are positioned inward in the width direction of the airframe within the skids.

### EFFECT OF THE INVENTION

According to the present invention, as the radiator can be formed in a large size outside the main body, it is possible to provide a wind receiving part of the radiator with a large area so that cooling performance may be improved. As the wind reception surfaces of the radiator are oriented in the longitudinal direction of the airframe, a wind is sufficiently received during a forward movement. As the lateral end of the radiator in the width direction projects outward beyond the lateral edge of the bottom surface of the main body, a wind is sufficiently received during a backward movement. The downwash generated by the rotation of the main rotor flows downward and in the direction of the rotation of the main rotor. Accordingly, the downwash blows on the lateral end of the radiator from the obliquely upward direction. Consequently, the radiator can receive a wind caused by the downwash during hovering.

Therefore, the unmanned helicopter provided with the radiator according to the present invention not only improves cooling performance during a forward movement but also improves cooling performance during a backward movement or hovering, which prevents the radiator from receiving a wind from the forward direction. Further, as the radiator is positioned inward in the width direction of the airframe within the skid, the unmanned helicopter is easily handled when transported on the ground or carried by a load carrier of a transportation vehicle. Still further, the space occupied by the airframe of the unmanned helicopter according to the present invention is not enlarged by the radiator, and the airframe is compact. As a result, the space necessary for transportation or parking may be small.

### BRIEF DESCRIPTION OF DRAWINGS

FIG. 1 shows a side view of an unmanned helicopter according to a first embodiment of the present invention.

FIG. 2 shows a front view of the unmanned helicopter according to the first embodiment of the present invention.

FIG. 3 shows a plan view of the unmanned helicopter according to the first embodiment of the present invention.

FIG. 4 shows a side view illustrating the constitution of the front part of the airframe of the unmanned helicopter according to the first embodiment.

FIG. 5 shows an enlarged plan view of an engine part of the unmanned helicopter according to the first embodiment.

FIG. 6 shows a side view of an unmanned helicopter according to a second embodiment of the present invention.

FIG. 7 shows a front view of the unmanned helicopter according to the second embodiment of the present invention.

FIG. 8 shows a plan view of the unmanned helicopter according to the second embodiment of the present invention.

FIG. 9 shows a front view illustrating an example of a conventional unmanned helicopter.

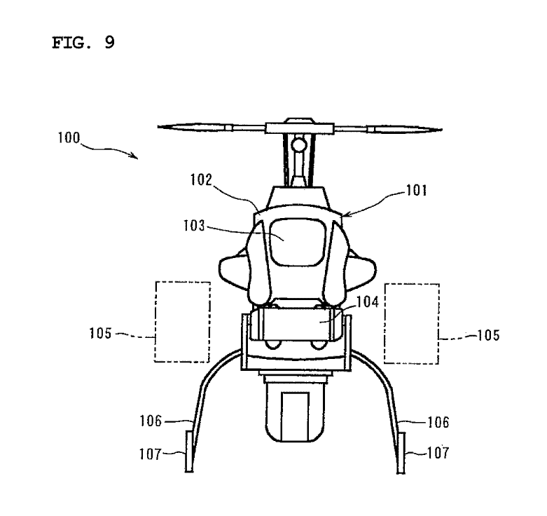

### BEST MODE FOR CARRYING OUT THE INVENTION

### First Embodiment

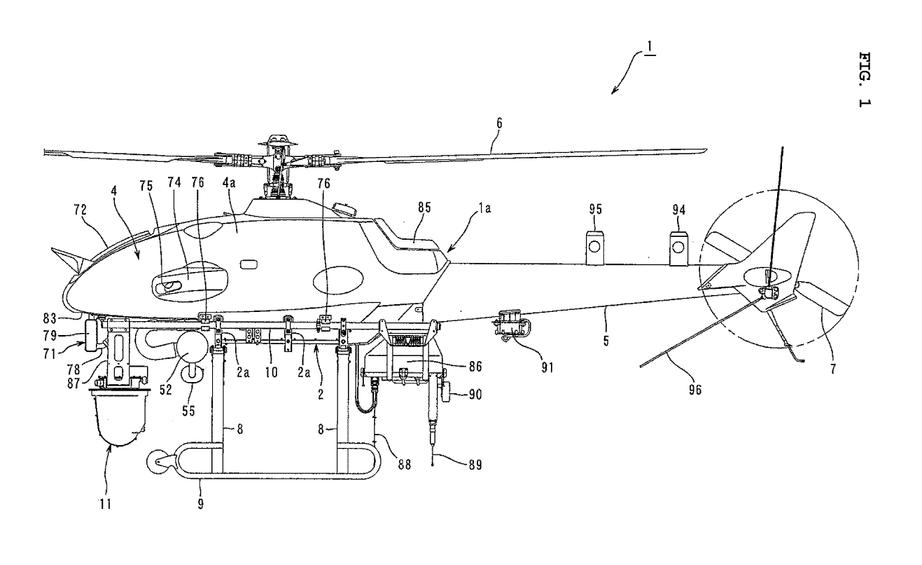

An embodiment of the unmanned helicopter according to the present invention will be described hereinafter in detail with reference to FIGS. 1 to 5.

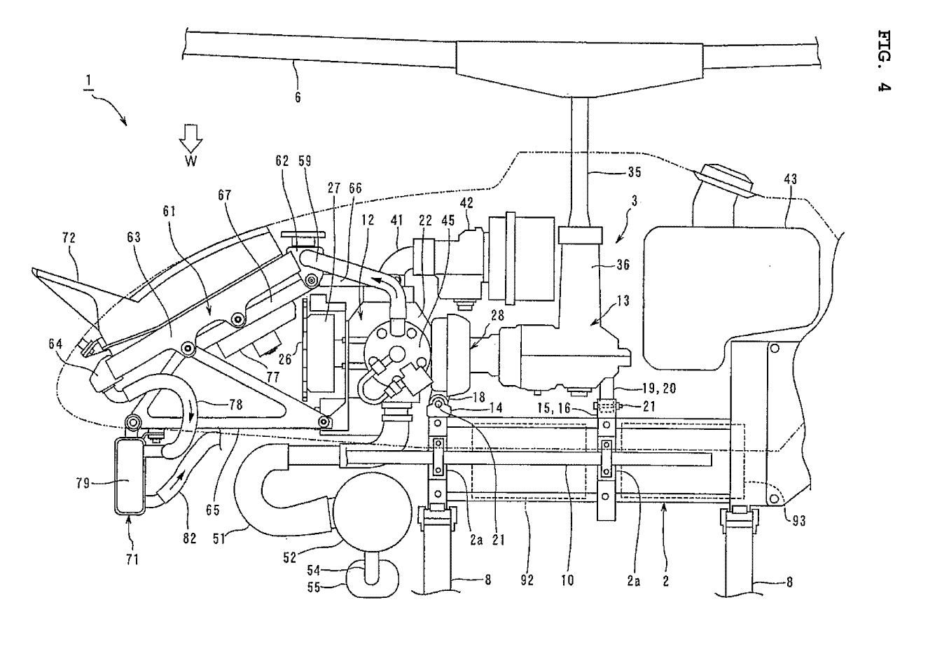

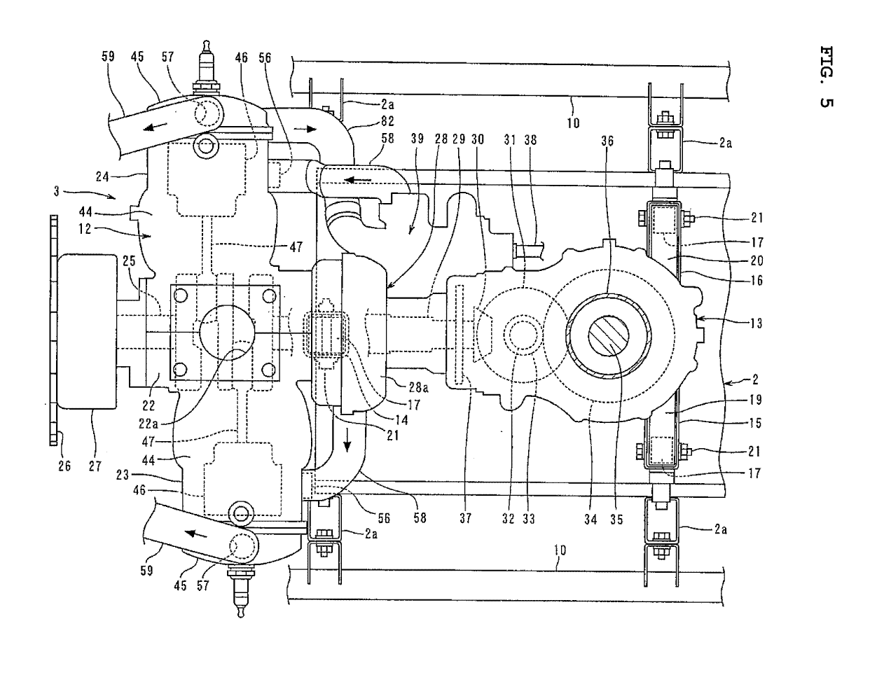

An unmanned helicopter 1 according to the embodiment has an airframe 1a including a body frame 2 described below (see FIG. 4 and FIG. 5), a power unit 3 mounted on the body frame 2, a main body 4 covering the outer circumference of the body frame 2 except the bottom area (see FIG. 1 to FIG. 3), and a tail body 5 connected to the rear end of the body frame 2. A main rotor 6 is provided on the upper part of the main body 4, and a tail rotor 7 is provided to the rear part of the tail body 5.

As shown in FIG. 4 and FIG. 5, the body frame 2 is formed in a shape of a hollow box extended in the longitudinal direction of the unmanned helicopter 1. A couple of support legs 8 disposed in the longitudinal direction of the airframe 1a is fixed on the lower end of the body frame 2. The support legs 8 are formed extendedly downward from the body frame 2. A couple of skids 9 and 9 at the left and the right sides is attached to the lower end of the support legs 8.

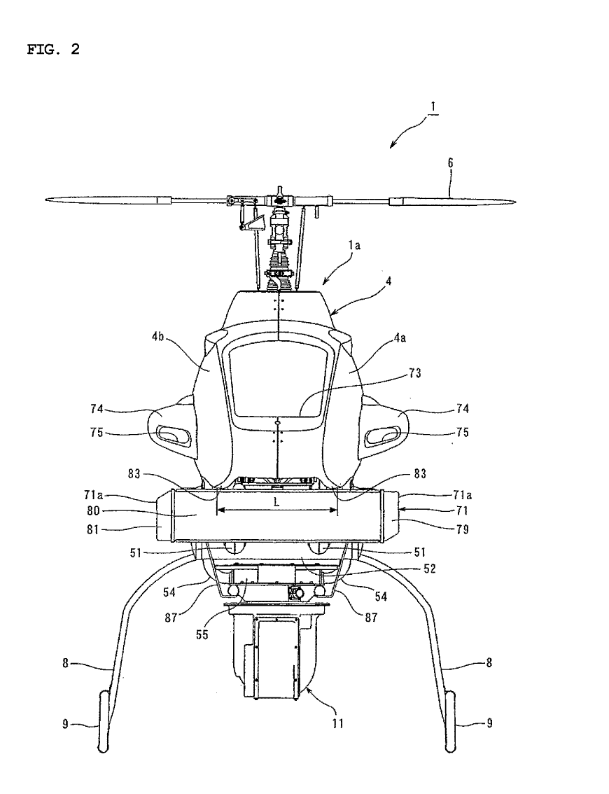

The upper ends of the support legs 8 are fixed on the body frame 2. The lower portions of the support legs 8 are gradually extended outward in the width direction of the airframe in the front view shown in FIG. 2. As shown in FIG. 2, the distance between a couple of the skids 9 and 9 provided at the lower ends of the support legs 8 is longer than the maximum width of the main body 4.

As shown in FIG. 4 and FIG. 5, a payload bar 10 is attached on the both sides in the width direction of the airframe 1a of the body frame 2 by a mounting bracket 2a. The payload bar 10 is used for attaching a mounted component such as a camera device 11 described below (see FIG. 1). The payload bar 10 is constituted by a pipe having a circle cross section, formed and secured in a length extended in the longitudinal direction of the airframe 1a from the front end to the rear end of the main body 4 in the side view shown in FIG. 1.

As shown in FIG. 4 and FIG. 5, the power unit 3 mounted on the body frame 2 is constituted by a water-cooled, two-cycle, horizontal opposed two-cylinder engine 12 and a power transmission device 13 for transmitting the power of the engine 12 to the main rotor 6. The power unit 3 is supported on a first to a third brackets 14 to 16 projectingly provided on the upper surface of the body frame 2 via an elastic member 17 (see FIG. 5). The first bracket 14 is disposed at the front end of the body frame 2 in the middle part in the width direction of the airframe 1a. The second bracket 15 and the third bracket 16 are disposed at positions more rearward than the position of the first bracket 14 and at the both ends in the width direction of the airframe 1a of the body frame 2.

The lower ends of a first to a third support stays 18 to 20 extended downward from the power unit 3 are attached on the first to the third brackets 14 to 16. In these three parts for mounting a component, the elastic member 17 is fixed on the lower ends of the first to third support stays 18 to 20, and the elastic member 17 is further fixed on the first to the third brackets 14 to 16 by fixing bolts 21. The axis of the fixing bolt 21 having been fixed on the first bracket 14 is oriented in the width direction of the airframe 1a, while the axis of the fixing bolt 21 having been fixed on the second and the third brackets 15 and 16 is oriented in the longitudinal direction of the airframe 1a.

As shown in FIG. 4 and FIG. 5, the engine 12 is provided with a crankcase 22 and a first and a second cylinder sections 23 and 24 projecting in the width direction of the airframe 1a from the crankcase 22. The crankcase 22 rotatably supports a crankshaft 25 in the middle part in the width direction of the airframe 1a.

The crankshaft 25 is provided in the crankcase 22 with its shaft oriented in the longitudinal direction of the airframe 1a. The front end of the crankshaft 25 projects frontward from the crankcase 22, and a flywheel having a starting gear 26 is attached to the front end of the crankshaft 25.

The rear end of the crankshaft 25 is connected to an input section (not shown) of an automatic centrifugal clutch 28 provided on the rear end of the crankcase 22. A clutch housing 28a of the automatic centrifugal clutch 28 is interposed between the crankcase 22 and the power transmission device 13 and connects these two components. An output section (not shown) of the automatic centrifugal clutch 28 is connected to a first power transmission shaft 29 of the power transmission device 13.

The power transmission device 13 includes the first power transmission shaft 29 extended rearward from the automatic centrifugal clutch 28, a second power transmission shaft 32 coupled with the rear end of the first power transmission shaft 29 by gears via bevel gears 30 and 31, and a main rotor shaft 35 coupled with the second power transmission shaft 32 by gears via spur gears 33 and 34. The main rotor shaft 35 passes through a guide section 36 provided projectingly upward on the power transmission device 13 and is guided above the power unit 3. The main rotor 6 is attached on the upper end of the main rotor shaft 35.

A drive gear 37 is attached in the middle part of the first power transmission shaft 29. The drive gear 37 meshes with an idle gear (not shown) which synchronizes with a tail rotor drive shaft 38 and a cooling water pump 39. The tail rotor drive shaft 38 is connected to the tail rotor 7 via belt type power transmission means (not shown) housed in the tail body 5.

As shown in FIG. 5, an intake port 22a is opened on the upper end of the crankcase 22. A carburetor 42 is connected to the intake port 22a via an air intake pipe 41 (see FIG. 4). A reed valve (not shown) is provided in the vicinity of the downstream side of the intake port 22a. The fuel of the engine 12 is supplied by a fuel tank 43 mounted on the rear end of the body frame 2.

A first cylinder section 23 and a second cylinder section 24 includes: a cylinder body 44 formed integrally with the crankcase 22; a cylinder head 45 attached on the end of the cylinder body 44; a piston 46; and a connecting rod 47.

Exhaust gas of the engine 12 is exhausted from an exhaust port (not shown) formed on the lower end of the cylinder body 44. As shown in FIG. 4, an exhaust chamber 52 is connected to the exhaust port via an exhaust pipe 51. The exhaust pipe 51 is provided on each of the first cylinder section 23 and the second cylinder section 24 and respectively connected to the ends in the width direction of the exhaust chamber 52. The exhaust chamber 52 is disposed in the middle part in the width direction of the airframe 1a below the engine 12 and supported by the engine 12 via the exhaust pipe 51. A muffler 55 is connected to a part below the exhaust chamber 52 via a pipe 54. Exhaust gas exhausted into the exhaust chamber 52 enters into the muffler 55 via the pipe 54 and exhausted in the air from a plurality of exhaust ports (not shown) formed on the lower end of the muffler 55.

A water jacket (not shown) for passing engine cooling water is formed in the cylinder body 44 and in the cylinder head 45. As shown in FIG. 5, the water jacket leads cooling water from a cooling water inlet 56 formed on the rear end of the cylinder body 44 to a cooling water outlet 57 formed on the upper end of the cylinder head 45. The cooling water inlet 56 is connected to a discharge outlet (not shown) of the cooling water pump 39 by a first cooling water pipe 58. The cooling water outlet 57 is connected to an inflow tank 62 of a first radiator 61 (see FIG. 4) described below by a second cooling water pipe 59.

As shown in FIG. 4, the first radiator 61 is constituted by a core section 63, the inflow tank 62 connected to the upper end of the core section 63, and an outflow tank 64 connected to the lower end of the core section 63. The first radiator 61 is supported on the crankcase 22 via a first stay 65 in a shape of a triangle in the side view extended in the front direction of the airframe 1a from a position below the crankcase 22, a second stay 66 extended in the forward direction of the airframe 1a from a position above the crankcase 22, and a third stay 67 connecting the both stays 65 and 66.

The first to the third stays 65 to 67 are provided in a couple in the width direction of the airframe 1a and support the both ends of the first radiator 61. Further, a second radiator 71 described below is attached on the front end of the first stay 65. The first radiator 61 constitutes the main radiator described in Claim 4 of the present invention while the second radiator 71 constitutes the radiator described in Claim 1 and Claim 2 of the present invention.

The first radiator 61 is provided in front of the engine 12 and slants down to the front. The core section 63 of the first radiator 61 faces to the main rotor 6. In addition, a wind guide 72 is attached on the upper part of the first radiator 61. The wind guide 72 leads a downwash W (a downward wind) caused by the rotation of the main rotor 6 to the core section 63. The wind guide 72 surrounds the core section 63 and is formed in a shape of a cylinder projecting upward above the core section 63.

The wind guide 72 is inserted into a cooling air intake 73 (see FIG. 2) formed on the upper surface on the front side of the airframe of the main body 4. The wind guide 72 is omitted from FIG. 2 for ease of understanding the shape of the cooling air intake 73.

The main body 4 according to the embodiment is formed in a shape which covers the outer circumference of an body frame 2 except the bottom area thereof. Further, the main body 4 is formed with a body left half 4a and a body right half 4b and separatable into two in the width direction of the airframe 1a. As shown in FIG. 2, the part corresponding to the cylinder head 45 of the first and the second cylinder sections 23 and 24 of the engine 12 in the main body 4 projects in the width direction of the airframe 1a. Each of the cylinder heads 45 and 45 is housed inside a projecting section 74. An air intake 75 is formed on the front end of the projecting section 74 and opens toward the front direction of the airframe 1a.

As shown in FIG. 1, the body left half 4a and the body right half 4b of the main body 4 is supported openably and closably in the width direction of the airframe 1a by the payload bar 10 provided on the side of the body frame 2 via a support member 76. The both halves 4a and 4b of the main body 4 are supported by the support member 76 swingably in the width direction of the airframe 1a around the payload bar 10. The both halves 4a and 4b of the main body 4 may be attached detachably to the payload bar 10 or to the body frame 2.

As the halves 4a and 4b of the main body 4 are closed, the body frame 2 in the front part of the airframe, the engine 12 supported on the body frame 2, the power transmission device 13, the main rotor shaft 35, the first radiator 61, and so forth are housed in the main body 4. On the other hand, as the halves 4a and 4b of the main body 4 are opened, the device, the member, and the like described above are exposed outside the airframe 1a.

As shown in FIG. 4, the first radiator 61 is provided with an electric fan 77. The electric fan 77 is actuated if the temperature of engine cooling water reaches a predetermined value and is positioned below the core section 63. When the electric fan 77 is actuated, outside air above the first radiator 61 is sucked into the core section 63. Cooling air having passed through the core section 63 further passes around the exhaust chamber 52 and is exhausted in the obliquely rear downward direction from the airframe 1a.

As shown in FIG. 4, the outflow tank 64 of the first radiator 61 is connected to an inflow tank 79 (see FIG. 2) of the second radiator 71 by a third cooling water pipe 78.

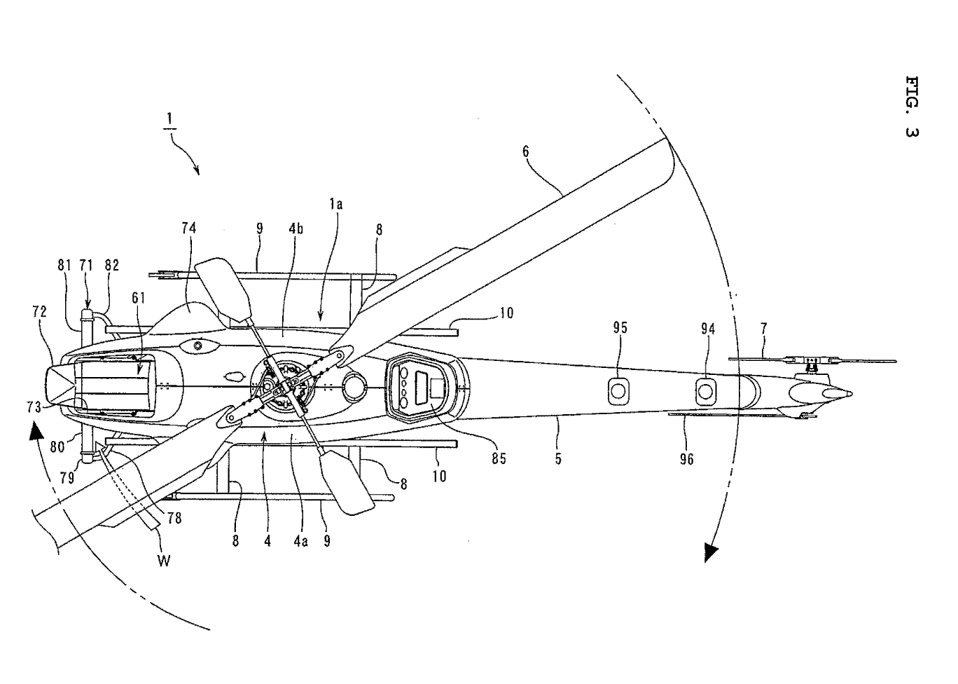

As shown in FIG. 2 and FIG. 3, the second radiator 71 is constituted by a core section 80 positioned in the middle part in the width direction of the airframe 1a, the inflow tank 79 connected to the end on the right side of the airframe of the core section 80, and an outflow tank 81 connected to the end of the left side of the airframe of the core section 63, and further is formed in a horizontally long shape which is longer in the width direction of the airframe 1a. The second radiator 71 assists the first radiator 61 in insufficient cooling performance. The outflow tank 81 of the second radiator 71 is connected to an intake port (not shown) of the cooling water pump 39 by a fourth cooling water pipe 82 (see FIG. 4).

As shown in FIG. 1, the second radiator 71 is positioned more frontward than the front end of the skid 9 in the side view of the airframe 1a and is provided extendedly downward from the vicinity of a bottom surface 83 of the front part of the main body. The wind reception surfaces of the second radiator 71 (the front surface and the back surface of the core section 80) are oriented in the longitudinal direction of the airframe 1a.

As shown in FIG. 2, the length of the second radiator 71 in the width direction of the airframe is longer than a width L of the main body bottom surface 83 in the vicinity of the second radiator 71. Specifically, as shown in the front view of FIG. 2, a lateral end 71a in the width direction of the airframe 1a of the second radiator 71 projects outward beyond the lateral edge of the main body bottom surface 83 in the vicinity of the second radiator 71 and is positioned more inward than the skid 9 within the width of the airframe 1a.

A control panel 85 is provided on the upper side of the rear part of the main body 4. The control panel 85 displays checkpoints, a result of a self diagnosis, and the like before a flight. Although not shown, display on the control panel 85 is confirmed also at the ground station.

An autonomous control box 86 is mounted on the lower part of the airframe behind the skid 9. The autonomous control box 86 houses a GPS control device necessary for autonomous control, a data communication device and an image communication device for performing communication with the ground, a control board with a control program built in, and so forth. The autonomous control is performed according to flight data such as the location and the speed of the airframe 1a, airframe 1a data such as the attitude and the direction of the airframe 1a, and operation state data such as the rotational speed and the throttle angle of the engine. According to the autonomous control, the unmanned helicopter 1 can fly in a manner in which an optimum flight condition can be achieved corresponding to the flight condition such as the weather condition and the laden weight by automatically selecting an operation mode and a control program prescribed in advance or by selecting an operation mode and a control program depending on an instruction from the ground station.

The unmanned helicopter 1 can fly by the autonomous control as described above. In addition, it is possible to manually operate the unmanned helicopter 1 by radio control according to the flight condition or various operation state data transmitted from the airframe 1a while the operator visually monitors the flight condition.

As shown in FIG. 1 and FIG. 2, the camera device 11 is disposed below the front end of the main body 4. The camera device 11 is attached on the front end of the payload bar 10 via a suspension bracket 87. The camera device 11 rotates around a pan shaft in the vertical direction to photograph images in an arbitrarily horizontal direction. In addition, an internal camera rotates around a tilt axis to photograph images in a direction at an arbitrary elevation angle and at an arbitrary depression angle.

A data antenna 88 for transmitting and receiving navigation data (digital data) such as operation state data necessary for the autonomous control and flight instruction data to and from the ground station is attached suspendedly from the side of the airframe 1a in the front part of the airframe in the vicinity of the autonomous control box 86. Further, an image data antenna 89 for transmitting image data as analog data photographed by the camera device 11 to the ground station is attached suspendedly from the side of the airframe 1a in the rear part of the airframe 1a in the vicinity of the autonomous control box 86. An indicating lamp 90 is provided to the rear part of the autonomous control box 86. The indicating lamp 90 displays abnormality of the airframe 1a and the amount of remaining fuel and thereby enables the operator on the ground to make visual recognition.

An azimuth sensor 91 based on terrestrial magnetism is provided on the bottom side of the tail body 5. The azimuth sensor 91 detects the direction of the airframe 1a such as east, west, south, and north. Further, as shown in FIG. 4, an attitude sensor 92 constituted by a gyro device is provided in the body frame 2. A control unit 93 for controlling the engine 12 and electrical equipment such as a collective servo motor (not shown) for controlling the main rotor is also provided in the body frame 2.

A main GPS antenna 94 and a sub-GPS antenna 95 are provided on the upper surface of the tail body 5. A remote control receiving antenna 96 for receiving a command signal from a remote controller is provided on the rear end of the tail body 5.

The unmanned helicopter 1 constituted as described above receives a wind on the front of the airframe 1a while moving forward. Accordingly, the air flows into the first radiator 61. On the other hand, the second radiator 71 formed outside the main body 4 is larger in the width direction of the airframe 1a than the main body 4. Accordingly, it is possible to provide a wind receiving part (a part which receives a wind caused by a flight) having a large area. In addition, the wind reception surfaces of the second radiator 71 are oriented in the longitudinal direction of the airframe 1a. As a result, when the unmanned helicopter 1 moves forward, a high cooling effect is obtained with the first radiator 61 and the second radiator 71.

When the unmanned helicopter 1 hovers, moves backward, or flights in other manners, it is not possible to receive a wind from the front. Therefore, the first radiator 61 cannot sufficiently cool cooling water.

On the other hand, because the lateral end in the width direction of the second radiator 71 projects outward beyond the lateral edge of the main body bottom surface 83, the projected part or the both sides of the second radiator 71 can receive a wind during a backward movement.

The downwash W generated by the rotation of the main rotor flows downward and also swirls in the direction of the rotation of the main rotor 6. Accordingly, the downwash W blows on the lateral end of the second radiator 71 from the obliquely upward direction. Specifically, when the main rotor 6 rotates clockwise in the plan view shown in FIG. 3, the downwash W blows on the second radiator 71 from the obliquely upward direction on the left side of the airframe 1a. In this case, the wind mainly blows on the part positioned at the left side of the airframe of the second radiator 71.

Consequently, the second radiator 71 not only receives the wind flowing along the side of the airframe 1a during a backward movement but also receives the downwash W generated by the rotation of the main rotor 6. As a result, the unmanned helicopter 1 according to the embodiment achieves a sufficient cooling effect by receiving a wind on the second radiator 71 even in a state in which the first radiator 61 provided at the front in the front part of the airframe does not easily receive a wind.

In addition, because the second radiator 71 is positioned inward in the width direction of the airframe 1a within the skid 9, the unmanned helicopter 1 is easily handled when transported on the ground or carried by a load carrier of a vehicle. Further in addition, according to the unmanned helicopter 1 according to the embodiment, the space occupied by the airframe 1a is not enlarged by the second radiator 71, and the airframe 1a is compact. Accordingly, the space necessary for transportation or parking may be small.

The second radiator 71 according to the embodiment is provided extendedly downward from the vicinity of the bottom surface 83 of the front part of the main body. Therefore, when the body left half 4a and the body right half 4b of the main body 4 are opened or detached from the airframe 1a, these components are not interfered with by the second radiator 71. As a result, regardless of the fact that the second radiator 71 is mounted, it is easy to open or remove the main body 4. Moreover, the main body 4 is widely opened as necessary.

### Second Embodiment

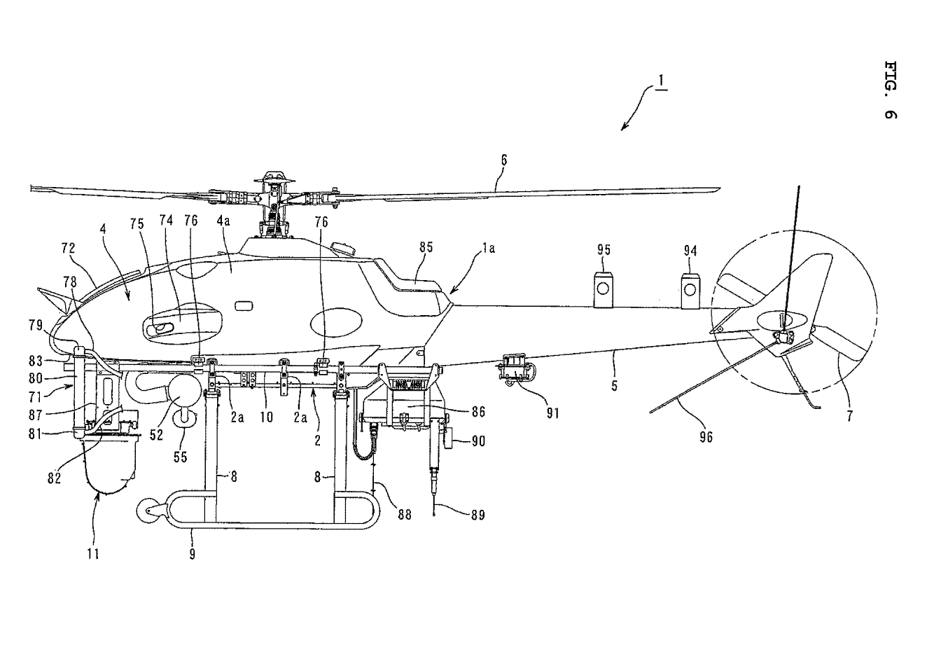

The unmanned helicopter according to the present invention can be constituted as shown in FIG. 6 to FIG. 8. In these drawings, a member equal to or equivalent to a member already described with reference to FIG. 1 to FIG. 5 is given the same reference numeral or symbol, and a detailed description thereof will not be repeated in an appropriate manner.

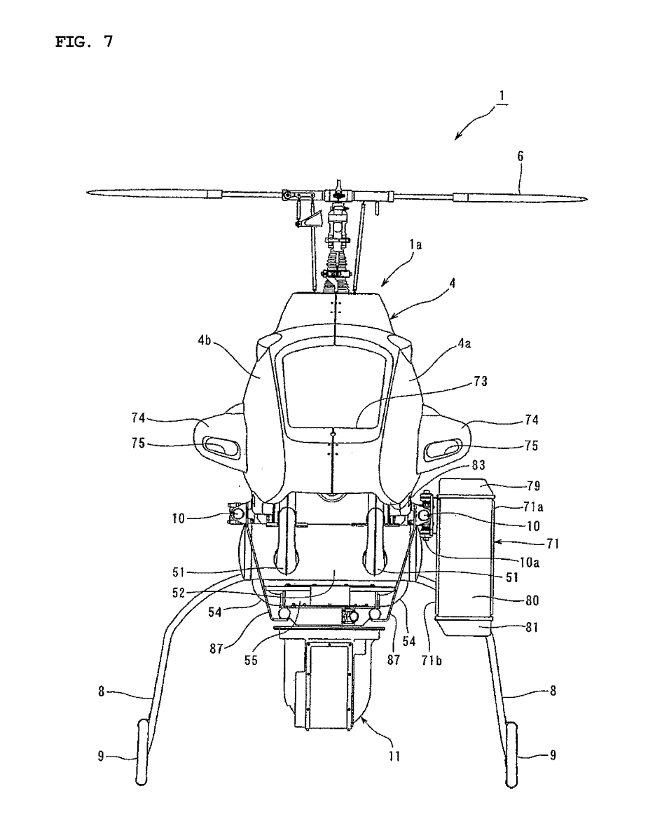

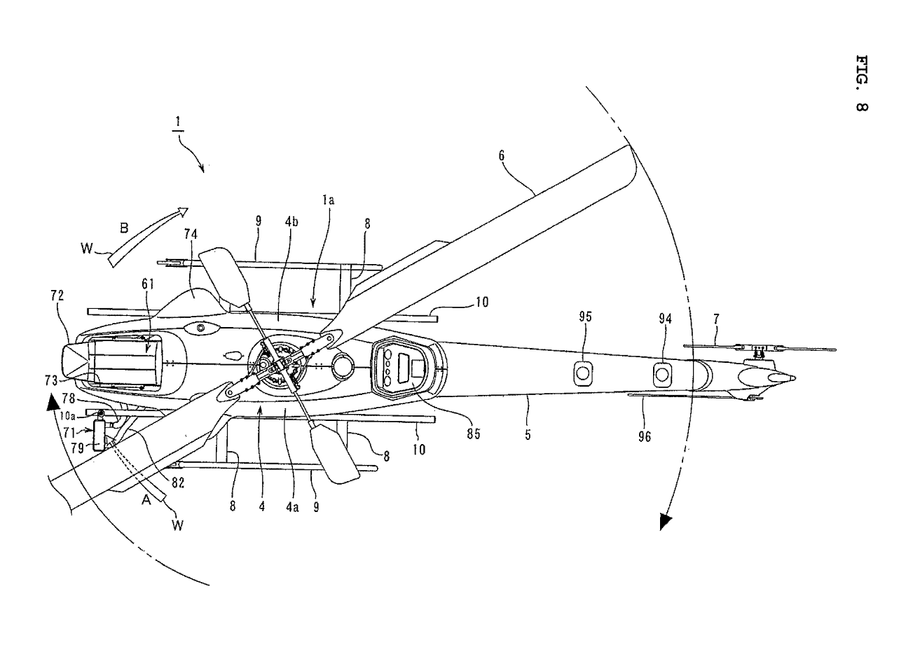

In the helicopter 1 according to the embodiment, the second radiator 71 formed in a horizontal long shape which is longer in the vertical direction is provided in a position below the main body 4 at the left side of the airframe 1a. The second radiator 71 shown in the second embodiment constitutes the radiator described in Claim 3 of the present invention. As shown in FIG. 7 and FIG. 8, the second radiator 71 according to the embodiment is attached to the payload bar 10 positioned at the left side of the airframe by a bracket 10a.

Specifically, as shown in FIG. 6, the second radiator 71 according to the embodiment is positioned more frontward than the front end of the skid 9 in the side view of the airframe 1a and is formed extendedly downward from the vicinity of the bottom surface 83 of the front part of the main body. In addition to this, the wind reception surfaces of the second radiator 71 are oriented in the longitudinal direction of the airframe 1a.

Because the second radiator 71 is provided extendedly downward from the vicinity of the bottom surface 83 of the front part of the main body, when the body left half 4a and the body right half 4b of the main body 4 are opened or detached from the airframe 1a, these components are not interfered with by the second radiator 71. As a result, regardless of the fact that the second radiator 71 is mounted, it is easy to open or remove the main body 4. Moreover, the main body 4 is widely opened as necessary.

As shown in FIG. 7 and FIG. 8, the lateral end 71a in the width direction of the airframe 1a of the second radiator 71 projects outward beyond the lateral edge of the main body bottom surface 83 in the vicinity of the second radiator 71 and is positioned more inward than the skid 9 in the width direction of the airframe 1a. Further, an inner end 71b in the width direction of the airframe 1a of the second radiator 71 is positioned outward beyond the lateral edge of the main body bottom surface 83.

The main rotor 6 generating the lift of the unmanned helicopter 1 rotates solely clockwise or counterclockwise. Accordingly, the downwash W generated by the rotation of the main rotor 6 always swirls around the main rotor shaft 35. As a result, the wind flowing from the backward direction of the airframe 1a during a backward movement interflows with the downwash W swirling downward from the main rotor 6 and makes an asymmetrical flow. Specifically, during a backward movement, the amount of a wind increases at one side of the airframe 1a, while the amount of a wind decreases at the other side thereof. As the second radiator 71 is provided on the side on which the amount of a wind increases, even a small type of the second radiator 71 can receive a wind so sufficiently that cooling performance is ensured.

As indicated by a chain double-dashed line in FIG. 8, when the main rotor 6 rotates clockwise in the plan view, a wind caused by the downwash W moving downward from the rear direction to the front direction is generated at the left side of the airframe 1a as indicated by an arrow A, while a wind caused by the downwash W moving downward from the front direction to the rear direction is generated at the right side of the airframe 1a as indicated by an arrow B. If the airframe 1a moves backward, a wind blows from the rear side of the second radiator 71. Accordingly, when the second radiator 71 is provided on the left side as shown in FIG. 8, the wind interflows with the downwash W caused by the main rotor 6. As a result, a strong wind blows on the second radiator 71.

On the other hand, if the second radiator 71 is provided at the right side of the airframe 1a, the wind caused by a backward movement and the wind caused by the downwash W generated by the rotation of the main rotor 6 blow in the opposite direction. Consequently, the wind is weakened, and a sufficient cooling effect cannot be obtained. Accordingly, as shown in FIG. 8, when the main rotor 6 rotates clockwise in the plan view, a sufficient cooling effect can be obtained by providing even a small type of the second radiator 71 on the left side of the airframe 1a. On the other hand, when the main rotor 6 rotates counterclockwise in the plan view, the second radiator 71 is provided at the right side of the airframe 1a.

The second radiator 71 according to the embodiment is provided on one side on which the downwash W generated by the rotation of the main rotor 6 flows in the front direction of the airframe 1a of one side and the other side in the width direction of the airframe 1a. As a result, the downwash W is received by the whole area of the core section 80. In addition, because the second radiator 71 is positioned inward in the width direction of the airframe 1a within the skid 9, the unmanned helicopter 1 is easily handled when transported on the ground or carried by a load carrier of a vehicle. Further in addition, in the unmanned helicopter 1 according to the embodiment, the space occupied by the airframe 1a is not enlarged by the second radiator 71, and the airframe 1a is compact. Accordingly, the space necessary for transportation or parking may be small.

The main body 4 disclosed in the first and the second embodiments described above is attached to the airframe 1a freely openably and closably in the width direction thereof. In other words, according to the unmanned helicopter 1, the engine 12 on the body frame 2, the power transmission device 13, the main rotor shaft 35, the main radiator 61, and so forth can be easily exposed by opening the main body 4. As a result, according to the first and the second embodiments, it is possible to produce the unmanned helicopter 1 which is not only easily transported but also easily serviced. In addition to this, because the second radiator 71 is formed extendedly downward from the vicinity of the bottom surface 83 of the front part of the main body, the main body 4 is opened or closed or attached or detached without interfered with by the second radiator 71. As a result, it is easy to open or close or attach or detach the main body 4. Moreover, the main body 4 is widely opened or closed as necessary.

In the second embodiment, an example in which the second radiator 71 is provided on one side of the airframe 1a is disclosed. The second radiator 71, however, may be provided on the both sides in the width direction of the airframe 1a. Further, in the first and the second embodiments described above, the unmanned helicopter 1 provided with the first radiator 61 and the second radiator 71 are described. However, cooling performance is improved by forming the wind reception surfaces of the second radiator 71 more largely. In this case, the engine 12 can be sufficiently cooled solely by the second radiator 71 without using the first radiator 61.

### INDUSTRIAL APPLICABILITY

The present invention can be applied not only to the unmanned helicopter 1 for photographing aerial images but also to an unmanned helicopter for applying agrochemicals and to an unmanned helicopter used for any other purpose.

1. An unmanned helicopter, comprising:
an airframe having a main body and a tail body continued to a back part of the main body;
a main rotor disposed above the main body and driven by an engine inside the airframe;
a tail rotor disposed in a rear part of the tail body;
a pair of support legs on left and right sides extending downward from left and right sides in a lower part of the main body;
a pair of skids on left and right sides positioned on bottom ends of the support legs and positioned out of the main body in a width direction of the airframe in a front view; and
a radiator at a position more frontward than front ends of the skids in a side view of the airframe, formed extendedly downward from a vicinity of a bottom surface of a front part of the main body, and having wind reception surfaces oriented to a longitudinal direction of the airframe,
wherein lateral ends of a radiator in the width direction of the airframe project outward beyond lateral edges of the bottom surface of the main body in the vicinity of the radiator in a front view and are positioned inward in the width direction of the airframe within the skids.

2. The unmanned helicopter according to claim 1,
wherein the radiator is formed in a horizontally long shape longer in a width direction having a length in the width direction of the airframe longer than the bottom surface of the main body and is provided across the width direction below the main body.

3. The unmanned helicopter according to claim 1,
wherein the radiator is formed in a horizontally long shape longer in the vertical direction having an inner edge positioned more outward than the lateral edge of bottom surface of the main body and is provided on one side on which at least a downwash generated by a rotation of a main rotor flows in a front direction of the airframe of one side and the other side in the width direction of the airframe.

4. The unmanned helicopter according to claim 1,
wherein the main body houses a body frame the engine supported on the body frame, a power transmission device, a main rotor shaft, and a main radiator;
the main body is formed in a shape which covers the outer circumference of the body frame except the bottom area and is separatable into two in the width direction of the airframe; and
one half and the other half of the main body is formed openably and closably in the width direction of the airframe around the body frame side.
